(19) United States
(12) Patent Application Publication
(10) Pub. No.: US 2026/0280452 A1
(43) Pub. Date: Sep. 17, 2026

(54) ELECTROADHESIVE FILM CARRIER FOR PACKAGING MACHINES

(71) Applicant: KRONES AG, Neutraubling (DE)

(72) Inventors: Fabian GOTZLER, Regensburg (DE); Andreas HACK, Osterhofen (DE)

(21) Appl. No.: 19/565,333

(22) Filed: Mar. 12, 2026

(30) Foreign Application Priority Data
Mar. 12, 2025 (DE) 102025109457.8

(51) Int. Cl. H02N 13/00; B65H 29/24

(52) U.S. Cl. CPC H02N 13/00; B65H 29/241; B65H 2301/44334

(57) ABSTRACT

A method for treating films, and in particular plastics material films, includes the steps of:
providing a first film carrier which is rotatable about a predefined first axis of rotation with a film rolled onto this film carrier
removing a first portion of the film by a second film carrier, which is preferably rotatable with respect to a second axis of rotation, and winding the film, at least in portions, onto the second film carrier, wherein
   at least one portion of the film is held at least temporarily on the second film carrier by an electroadhesive force.

### CROSS REFERENCE TO RELATED APPLICATION

This application claims benefit to German Patent Application Serial No. 10 2025 109 457.8, filed Mar. 12, 2025, the contents of which are incorporated herein by reference.

### BACKGROUND OF THE INVENTION

The present invention relates to a method for treating films, in particular within the context of a packaging process and, for example, within the context of a labeling method or within the context of a method of applying films, and in particular shrinkable films, to containers, as well as an apparatus for treating films.

In the prior art, films are used in various places in the packaging industry, for example for labeling or packaging containers or container assemblies.

It is known that films or labels are suctioned using a vacuum. For example, a film roll can be rotated on a tension mandrel using an electric motor, and the beginning of the film can be located using a camera system. After detection, the beginning of the film is brought into position and a suction mandrel with a bellows suction device moves towards the film roll with a translational movement.

After activating a vacuum pump and with the suction mandrel moving in the opposite direction, the initial portion detaches. Simultaneously, the film roll is unwound via a rotational movement of the tension mandrel and is wound via the rotational movement of the suction mandrel. After a full turn of the suction mandrel, the vacuum can be released again. The carriage of the suction mandrel moves further away from the film roll and positions itself so that a welding blade can push the film downwards and join it to another film. After the welding, the remainder of the film on the suction mandrel is transferred to the roll of the other film and wound up again via rotation of the tension mandrel.

The disadvantages of the prior art described here are that the method described above is very complex. Many individual steps are required, such as rotation, bringing in, suctioning in the film, and releasing the film. Accordingly, this method also requires many components such as motors, holding mandrels, holding strips, and the like.

Furthermore, the method described above is relatively inflexible. For example, if not all suction openings are covered due to the dimensions of the film, a waste of negative pressure can occur.

A further problem is that the film is only suctioned to specific points, which can lead to its deformation. In addition, the suction devices also cause a high level of noise pollution.

EP 0 031 383 B1 describes an apparatus for fastening labels. Here a transparent label is separated from a paper substrate and is charged with static electricity during this separation.

A method and an apparatus for arranging labels on containers are known from U.S. Pat. No. 3,508,993. Here, an electrical charge is applied to the surface of the containers, and a vacuum is used to take a film from a stock.

U.S. Pat. No. 3,726,520 DESCRIBES AN APPARATUS FOR TRANSPORTING SHEETS OF PAPER using electrostatic charging.

A labeling apparatus and a labeling method are known from WO 95/11832 A1. A generator for producing electrical charges is provided here.

### SUMMARY OF THE INVENTION

In a method according to the invention for treating films, in particular plastics material films, in a method step a first film carrier, preferably a film roll carrier (also referred to as a roll core (in particular in the form of a cardboard core or plastics material core)), is provided which is rotatable about a predefined first axis of rotation, wherein a film is rolled onto this film carrier (or a film carrier with a film rolled onto this film carrier).

Preferably, a film mandrel is also provided which can be inserted into the roll core and can thus pick up the film roll. This film mandrel is preferably rotatable. It would also be possible to designate this film mandrel as film carrier, or in this case as the first film carrier.

In a further method step, a first portion of the film is removed (from the first film carrier) by a second film carrier, wherein the second film carrier is rotatable with respect to a second axis of rotation and the film is wound at least in sections onto the second film carrier.

In the prior art, the second film carrier is a shaft and in particular an additional suction shaft on which at least one and preferably a plurality of suction devices and in particular several bellows suction devices are arranged.

According to the invention, at least one portion of the film is held at least temporarily on the second film carrier by an electroadhesive force and/or at least one portion of the film is arranged at least temporarily on the second film carrier by an electroadhesive force.

It is therefore proposed that the bellows suction device(s) of the suction shaft be replaced by electroadhesively operating elements and in particular electroadhesion pads or by an electroadhesion shaft. The (first) film carrier or the machine mandrel is then preferably not equipped with electroadhesion.

The first film carrier is thus the roll core, on which the roll is originally wound. The second film carrier is in particular a suction shaft which takes over the film, wherein the suction effect is caused by an electroadhesive force.

A film carrier is thus understood to be a device or element that is suitable and intended for carrying a film or a film portion. Preferably, at least one of the film carriers is configured or arranged to be rotatable with respect to a predetermined axis of rotation. Preferably, both film carriers are configured or arranged to be rotatable with respect to a predetermined axis of rotation. Preferably, the film is unwound and/or wound up by a rotation of the film carrier with respect to this axis of rotation.

Preferably, (in addition to the first and the second film carrier) a further film carrier is also provided to which the film is transferred from the second film carrier. This is in particular a second machine mandrel onto which the film is transferred from the second film carrier. Preferably, the second film carrier, i.e. in particular the suction shaft between the first film carrier or the first machine mandrel and the second machine mandrel, is translationally movable.

Therefore, in contrast to the prior art, it is proposed that the film or film portion is not held by suction, but by an electroadhesive force.

Particularly preferably, the film is made of a material selected from a group of materials which includes LDPE or LLDPE (in particular in the case of film rolls) or PP, PVC, PE, PS or paper (in particular in the case of label rolls).

Particularly preferably, the film servers for labeling containers. Preferably, the film is applied to the outer circumference of containers. The film preferably has at least one and preferably a plurality of labels.

It should be noted that several applications for the invention are possible. In particular, the invention can be used when portions of two film rolls are to be joined together (also known as splicing). Thus, the invention can also be used for example when containers are to be labeled.

A voltage applied between two objects can cause these two objects to adhere to one another. This effect is called electroadhesion and is already used in a wide variety of ways. This allows, for example, robotic grippers to fix objects in place. The invention proposes to transport thin films in this manner and/or to remove them from another device, here the first film carrier.

Particularly preferably, the film has a predetermined thickness, depending on its type and/or application. If the film is a shrink film, it preferably has a thickness greater than 10 μm, preferably greater than 15 μm, preferably greater than 20 μm, preferably greater than 25 μm, and particularly preferably greater than 30 μm. Preferably this thickness is less than 300 μm, preferably less than 250 μm, preferably less than 200 μm, preferably less than 150 μm, preferably less than 100 μm.

If the film is a film of label rolls, it preferably has a thickness greater than 10 μm, preferably greater than 15 μm, preferably greater than 20 μm, preferably greater than 25 μm, and particularly preferably greater than 30 μm. Preferably this thickness is less than 350 μm, preferably less than 300 μm, preferably less than 250 μm, preferably less than 200 μm, preferably less than 160 μm.

In a further preferred method, at least one portion of the second film carrier (and in particular at least one electrode of the second film carrier) is applied with an electrical voltage in order to generate the electroadhesive force in this way. Preferably this voltage is greater than 200 V, preferably greater than 400 V, preferably greater than 600 V, preferably greater than 800 V.

This voltage is preferably less than 20 kV, preferably less than 18 kV, preferably less than 16 kV, preferably less than 14 kV, preferably less than 12 kV and particularly preferably less than 10 kV and particularly preferably less than 8 kV.

Particularly preferably, the second film carrier is applied with a voltage greater than 200 V, preferably greater than 400 V, preferably greater than 600 V. Particularly preferably, the second film carrier is applied with a voltage less than 10 kV, preferably less than 8 kV, preferably less than 6 kV.

Preferably, the current strength to which the second film carrier is applied with is in the range of less than mA.

These power, current and voltage dimensions have proven promising, as they achieve a sufficient holding force while simultaneously reducing or eliminating the risk to the user.

In a further preferred method, the second film carrier is moved translationally with respect to the first film carrier, at least temporarily. Particularly preferably, the first film carrier (translational) remains stationary. The second film carrier is preferably moved towards the first film carrier.

This movement allows the second film carrier to be preferably brought into a position in which it can receive the aforementioned portion of the film. This removal is preferably achieved through the electroadhesive forces described above.

Preferably, the film can be transferred to a further film carrier and/or to a splicing unit by moving the second film carrier.

Particularly preferably, the translational movement occurs perpendicular to the aforementioned axis of rotation. However, a translational movement in the direction of the axis of rotation would also be possible, or a movement composed of both components.

Preferably, the first axis of rotation and the second axis of rotation are parallel to each other. Particularly preferably, the two axes of rotation to remain parallel to each other even during the translational movement.

In a further preferred method, an initial portion of the film is identified that is arranged and, in particular, rolled up on the first film carrier. This identification is preferably carried out by a sensor device. Particularly preferably, this sensor device is an image recording device. As described below, the sensor device can also be a measuring device that determines an electrical power consumption of the second film carrier or the suction shaft and/or electroadhesion shaft. Furthermore, the beginning (of the film) can also preferably be identified by changing the electric field.

In a preferred embodiment, the initial portion has at least one marking which serves to identify the initial portion. Particularly preferably, the first film carrier is rotated with respect to its axis of rotation for the purpose of identifying the initial portion.

This initial portion is preferably held at least temporarily on the second film carrier or the suction shaft/electroadhesion shaft by the electroadhesion holding force.

Particularly preferably, the aforementioned voltage is a direct voltage. However, it would also be possible to use a slightly alternating alternating voltage or a direct voltage whose voltage level fluctuates, for example, between 3000 V and 4000 V.

In a further preferred method, the voltage applied to the second film carrier is changed at least temporarily, and preferably reversed. In this way, the detachment of the film from the second film carrier can be achieved or facilitated.

In a further preferred method, the power consumption of the second film carrier is determined and/or measured at least temporarily. In addition, an electric field and/or a change in the electric field can also be measured. Particularly preferably, an adhesion of the film to the second film carrier is recognized taking into account a measurement result of this measurement.

Preferably, a control unit can be used to monitor the power consumption and/or the electric field and/or the change in the electric field. By measuring the power consumption (and/or the electric field or its change), it may be possible to eliminate the need for a camera device, which in the prior art is used to identify the initial portion of the film. This also eliminates the need for a special marking or a corresponding sticker on the film.

If the film adheres to the second film carrier, a higher power consumption (and/or a change in the electric field) is to be expected than without such adhesion. In this way, it can also be determined whether the film is adhering to the film carrier completely, i.e., along the longitudinal direction of the film carrier.

Preferably, the second film carrier has one or several electrodes. The second film carrier is particularly preferably configured as a film carrier roll (in particular as an electroadhesion roll).

In a further advantageous method, proper adhesion of the film to the second film carrier (i.e. in particular the suction shaft) is inspected and/or monitored, in particular by using a camera device.

Due to the electric field resulting from the application of a high voltage to the second film carrier and/or the electrode(s) and the resulting Coulomb force between the film carrier and the film, this film can adhere to the second film carrier similarly to the case of electrostatic charging.

The second film carrier, which is in particular symmetrically configured, can preferably be moved translationally and rotationally, or is moved translationally and rotationally. In addition, the second film carrier can remove the film (from the first film carrier) and/or tear off a sticker on the film.

The individual electrode(s) can be clamped and connected, and in particular clamped and connected inside the second film carrier.

In addition, lines that supply the electrodes with electrical energy can be led out of the film carrier via one or several openings at a connection region, e.g. a connecting flange. This procedure allows for a supply of power even if rotations of the film carrier are permitted only to a limited extent.

In a further preferred embodiment, the electrical voltage for the electrodes is provided by a voltage converter. Furthermore, the voltage is preferably controlled by a control device.

However, it would also be possible to transfer the electrical voltages to the film carrier for example using a slip ring. Alternatively, it would be possible to transfer the voltages using mounting devices that mount the second film carrier.

The present invention is further directed to an apparatus for treating a film, in particular for packaging purposes and in particular for a packaging machine or labeling machine, comprising a first film carrier on which the film can be rolled up and/or is rolled up. Preferably, the film carrier is a film roll carrier, which is therefore suitable and intended in particular for carrying a film roll.

It is thus possible and preferred for the film to be rolled onto a roll core (preferably made of cardboard or plastics material). A machine mandrel or film roll mandrel (which could however also be designated as the first film carrier) is inserted into the roll core of the film roll and preferably picks up the film roll including the core.

Here the first film carrier is rotatable with respect to a first predetermined (in particular geometric) axis of rotation. Furthermore, the apparatus has a second film carrier which is rotatable with respect to a second predetermined (in particular geometric) axis of rotation and which is suitable and intended to take over a portion of a film arranged and in particular rolled up on the first film carrier, and preferably to roll up this portion at least in portions.

According to the invention, the second film carrier is suitable and intended to pick up at least a portion of the film at least temporarily by an electroadhesive force and/or to hold it by an electroadhesive force.

In the context of this invention, a packaging machine is understood to be, in particular, a machine which processes film-like materials or which has a film supply, such as a wrapping machine or a buffering machine for film-like material.

Particularly preferably, the apparatus has a drive device to achieve a rotational movement of the second film carrier. In particular, the drive device is an electric motor, and in particular a servo motor.

Particularly preferably, the second film carrier, and in particular an outer surface of the second film carrier, is symmetrical with respect to a plane which is perpendicular to the axis of rotation.

This symmetrical construction ensures that the second film carrier remains in constant contact with the film when rotated around its axis of symmetry. In this way, a motor drive for the second film carrier could be omitted if necessary, since the film mounted on the second film carrier could be unrolled externally via frictional forces. More precisely, the second film carrier could be driven by frictional forces on the first film carrier.

The force acting on the film is distributed more or less homogeneously over the entire length of the second film carrier or the electroadhesion cylinder, and the length of the film roll no longer plays a role in terms of media consumption.

The increase in the flexibility made it possible to expand the previous film specification, thus increasing the number of possible applications.

By eliminating the generation of vacuum and compressed air, noise pollution can be reduced.

In a further preferred embodiment, the apparatus has at least one detection device that is suitable and intended for identifying an initial portion of the film. Preferably, this detection device is a measuring device that determines the electrical power consumption of the second film carrier. Alongside this, or in addition, a measuring device can also be provided which is suitable and intended to determine an electric field or a change in an electric field.

The apparatus particularly preferably has a voltage converter device to provide voltages, and in particular direct voltages. This voltage converter device is particularly preferably suitable and intended for applying direct voltages of different polarities to the second film carrier.

Particularly preferably, the second film carrier has at least one electrode to which a voltage can be applied, wherein this voltage is preferably greater than 1 kV.

Preferably, the second film carrier has at least two and preferably a plurality of electrodes. Preferably, several of these electrodes are insulated from each other.

Particularly preferably, the second film carrier can be applied with an electrical voltage in order in this way to achieve an (electroadhesive) hold of the film to this second film carrier. In particular, an outer surface of the film carrier is equipped in such a way that a film can be held thereon.

In a further advantageous embodiment, a voltage source is provided to apply an (electrical) voltage to the carrier.

In a further advantageous embodiment, the apparatus has a drive device which is suitable and intended to move at least one film carrier translationally with respect to the other film carrier. Particularly preferably, the drive device has an electric motor and in particular a servo motor.

Preferably, this drive device is suitable and intended to move the second film carrier with respect to the first film carrier and/or with respect to the aforementioned further film carrier. Preferably, the first film carrier and the further film carrier are configured to be translationally stationary.

In this way, for example the second film carrier can be moved to the first film carrier, in particular for the takeover of a film portion. This translational movement is particularly preferably carried out in a direction perpendicular to the axis of rotation of the first film carrier.

In a further advantageous embodiment, the apparatus has a measuring device which is suitable and intended for measuring electrical energy absorbed by the second film carrier.

Additionally or alternatively, a measuring device can also be provided which is suitable and intended for determining an electric field and/or for determining a change in an electric field.

Particularly preferably, the apparatus includes a display device which provides information to a user as to whether a film is properly held on the second film carrier.

In a further preferred embodiment, the second film carrier is configured such that an electroadhesive holding force for holding the film on the second film carrier is substantially constant along its axis of rotation. Particularly preferably, a holding force fluctuates along the axis of rotation by at most 20%, preferably and at most 15%, preferably and at most 10%, and particularly preferably and at most 5%. In this way, a uniform hold of the film on the second film carrier can be achieved.

In a further preferred embodiment, the second film carrier has at least one, preferably at least two, and particularly preferably at least four electrodes.

Preferably, here at least one or several electrodes extend in the longitudinal direction of the second film carrier, or along its axis of rotation. It would also be possible for several electrodes to be arranged side by side along the axis of rotation, in particular in alternating fashion. In alternating fashion here means that positive and negative electrodes (or, in operation, positively and negatively charged electrodes along the axis of rotation) are arranged one after the other.

It would also be possible for the electrodes to extend side by side in the direction of the axis of rotation and to be spaced apart from each other in the circumferential direction of the second film carrier.

Particularly preferably, the outer surface of the second film carrier is configured to be smooth or approximately smooth. The surface of the second film carrier is particularly preferably smooth in both the longitudinal direction and the circumferential direction.

In this way, a particularly uniform adhesion of the film to the outer surface of the second film carrier can be achieved. Preferably, the surface of the second film carrier is processed at least in portions in order to achieve a certain maximum roughness.

In a further preferred embodiment, the apparatus is a labeling machine. In particular, the apparatus is a labeling machine for labeling containers.

The present invention is further directed to a film carrier for carrying and rolling up films, wherein the film carrier extends in a longitudinal direction and wherein the film carrier has a mounting device which allows a rotatable mounting of the film carrier with respect to an axis of rotation extending in the longitudinal direction.

Preferably, the film carrier has a receiving device for receiving a rod-like body extending in the longitudinal direction or a fastening device for attaching a rod-like body extending in the longitudinal direction. Preferably, this rod-like body is rotatable with respect to the film carrier and/or rotatable with respect to the longitudinal direction.

According to the invention, the film carrier has a cylindrical and in particular a circular-cylindrical outer surface, wherein preferably this outer surface has a constant cross section along the longitudinal direction and at least one electrode that can be applied with an electrical voltage in such a way that an electroadhesive holding force for holding plastics material films can be generated on the outer surface.

The (second) film carrier is particularly preferably symmetrical with respect to a central plane which extends perpendicular to its axis of rotation.

Particularly preferably, an electrical power consumption of the second film carrier can be monitored.

The material of the outer surface of the film carrier is of some importance.

There is a quadratic proportionality between the applied voltage and the layer thickness of the dielectric relative to the holding force. Therefore, a large influence can be exerted by varying these control variables. The largest electric field can be generated at a maximum voltage and a minimum layer thickness of the dielectric. However, it should be noted that these two parameters influence each other with regard to electrical dielectric strength.

The latter is described by the electric field strength at which an irreversible increase in conductivity occurs in a dielectric. Depending on the choice of dielectric, in this way the maximum possible material-specific electric field can be described and the maximum theoretical tensile stress can be determined.

Particularly preferably, the outer surface of the film carrier and/or the electrode consists of a material selected from a group of materials which includes quartz, glass, mica, polyethylene, polymethyl methacrylate, polystyrene, porcelain, or polyvinyl chloride.

In a further preferred embodiment, the film carrier has a diameter which is between 30 mm and 200 mm, preferably between 50 mm and 150 mm.

In a further preferred embodiment, the film roll carrier has a length which is between 100 mm and 3000 mm, preferably between 200 mm and 2000 mm, and particularly preferably between 300 mm and 1000 mm.

### BRIEF DESCRIPTION OF THE DRAWINGS

Further advantages and embodiments can be seen in the accompanying drawings, in which:

FIG. 1 shows a representation of a film carrier according to the prior art;

FIG. 2 shows a film carrier according to the invention or a suction shaft in a first embodiment;

FIG. 3 shows a film carrier according to the invention or a suction shaft in a second embodiment;

FIG. 4 shows a film carrier according to the invention or a suction shaft in a third embodiment.

### DETAILED DESCRIPTION OF THE INVENTION

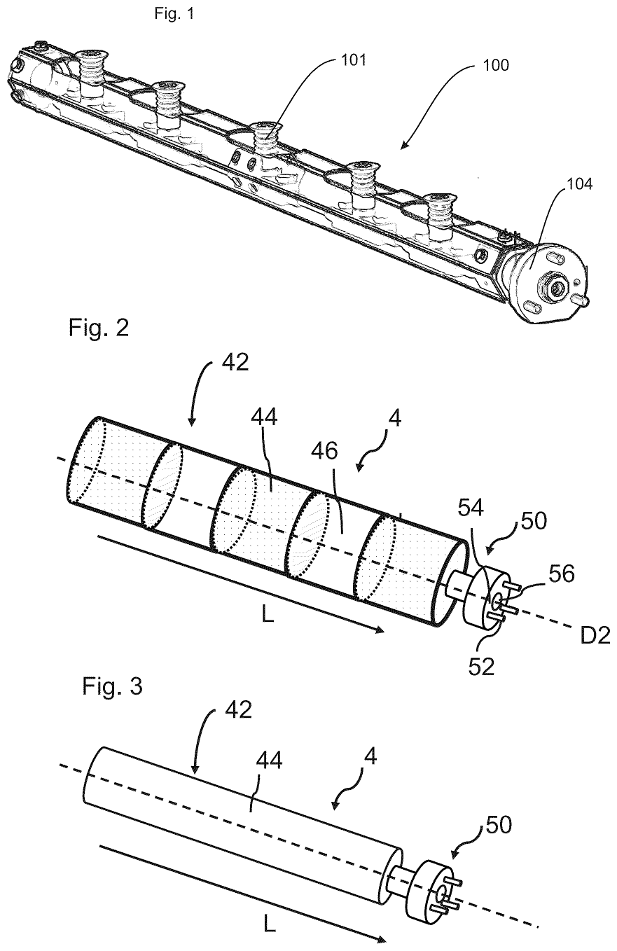

FIG. 1 shows a film carrier 100 or a suction shaft according to the prior art. This film carrier has a plurality of suction devices by which a film (not shown) can be suctioned onto the film carrier 100. Reference sign 104 denotes a flange.

FIG. 2 shows a film carrier 4 according to the invention in a first embodiment. This film carrier extends in a longitudinal direction L and has a substantially cylindrical outer surface 42.

In the longitudinal direction L, several electrodes 44, 46 are arranged next to each other. These electrodes also have a cylindrical profile.

Reference sign 50 designates a mounting device which is used to mount the (second) film carrier rotationally with respect to an axis of rotation D2.

Reference Sign 56 Designates a Circular Recess.

Reference sign 52 indicates a pin via which the individual electrodes 44, 46 can be supplied with a voltage. Reference sign 54 designates a flange.

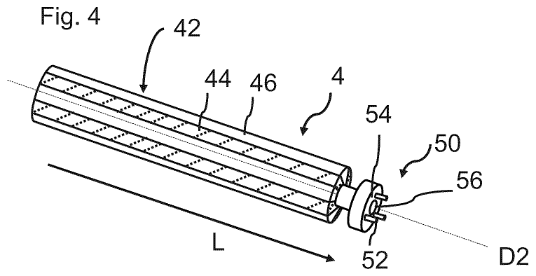

FIG. 3 shows a further embodiment of a (second) film carrier 4 according to the invention. In this embodiment, only one electrode 4 is provided, which here also has a circular-cylindrical outer surface.

FIG. 4 shows a further embodiment of a (second) film carrier 4 according to the invention. This film carrier here has, in turn, a plurality of electrodes 44, 46, which here however extend in the longitudinal direction L and are arranged next to each other in a circumferential direction of the film carrier.

It is pointed out that all features which have been described with reference to the method are also correspondingly disclosed for the apparatus, which means in particular that the corresponding apparatus comprises devices which are suitable and intended for carrying out the particular methods. Furthermore, features which were described with reference to the apparatus are also correspondingly applicable to the method or methods. This means that the methods are carried out using the corresponding apparatus features.

The applicant reserves the right to claim all features disclosed in the application documents as essential to the invention, provided that they are novel over the prior art individually or in combination. It is further pointed out that features which can be advantageous in themselves are also described in the individual figures. A person skilled in the art will immediately recognize that a particular feature described in a figure can be advantageous even without the incorporation of further features from this figure. Furthermore, a person skilled in the art will recognize that advantages can also result from a combination of several features shown in individual or in different figures.

1. A method for treating films, comprising the steps:
providing a first film carrier which is rotatable about a predefined first axis of rotation with a film rolled onto this film carrier
removing a first portion of the film by a second film carrier, which is rotatable with respect to a second axis of rotation, and winding the film, at least in portions, onto the second film carrier,
wherein
at least one portion of the film is held at least temporarily on the second film carrier by an electroadhesive force.

2. The method according to claim 1,
wherein
at least one portion of the second film carrier is applied with an electrical voltage in order to in this way generate the electroadhesive force.

3. The method according to claim 1,
wherein
at least temporarily the second film carrier is moved translationally with respect to the first film carrier.

4. The method according to claim 1,
wherein
an initial portion of the film arranged on the first film carrier is identified.

5. The method according to claim 1,
wherein
an electrical power consumption and/or an electric field of the second film carrier is determined at least temporarily.

6. An apparatus for treating a film, comprising a first film carrier on which the film can be rolled up, wherein the first film carrier is rotatable with respect to a first predetermined axis of rotation, and comprising a second film carrier which is rotatable with respect to a second predetermined axis of rotation and which is configured to take over a portion of a film arranged on the first film carrier,
wherein
the second film carrier is configured to hold at least a portion of the film at least temporarily by an electroadhesive force.

7. The apparatus according to claim 6,
wherein
the second film carrier is a shaft which is configured for pulling on and/or holding and/or suctioning the portion of the film.

8. The apparatus according to claim 6,
wherein
the second film carrier is configured to be applied with an electrical voltage in order to thus achieve a hold of the film to the second film carrier.

9. The apparatus according to claim 7,
Wherein
the second film carrier is configured to be applied with an electrical voltage in order to thus achieve a hold of the film to the second film carrier.

10. The apparatus according to claim 6,
wherein
the apparatus has a drive device which is configured to move at least one film carrier translationally with respect to the other film carrier.

11. The apparatus according to claim 6,
wherein
the apparatus has a measuring device which is configured for measuring electrical energy absorbed by the second film carrier and/or an electric field and/or a change in an electric field.

12. The apparatus according to claim 6,
wherein
the second film carrier is configured such that an electroadhesive holding force for holding the film on the second film carrier is substantially constant along its axis of rotation.

13. The apparatus according to claim 6,
wherein
the second film carrier has at least one electrode.

14. The apparatus according to claim 6,
wherein
the apparatus is a labeling machine or a packaging machine.

15. A film carrier for carrying films, wherein the film carrier extends in a longitudinal direction, and wherein the film carrier has a mounting device which is configured to allow a rotatable mounting of the film carrier with respect to an axis of rotation extending in the longitudinal direction,
wherein
the film carrier has a circular-cylindrical outer surface which has a constant cross section and at least one electrode that is configured to be subjected to an electrical voltage in such a way that an electroadhesive holding force for holding films is generated on the outer surface of the film carrier.
